(19) United States
(12) Patent Application Publication
(10) Pub. No.: US 2026/0121197 A1
(43) Pub. Date: Apr. 30, 2026

(54) BATTERY MODULE ASSEMBLY

(71) Applicant: FCA US LLC, Auburn Hills, MI (US)

(72) Inventor: Zachary Cook, Auburn Hills, MI (US)

(21) Appl. No.: 18/932,750

(22) Filed: Oct. 31, 2024

(51) Int. Cl. H01M 50/258; H01M 50/209; H01M 50/224; H01M 50/249

(52) U.S. Cl. CPC H01M 50/258; H01M 50/209; H01M 50/224; H01M 50/249

(57) ABSTRACT

A battery module assembly includes a frame, a first and a second cross-member bracket; a first battery module and a second battery module. The first and second cross-member brackets are configured on the battery frame and define first opposing slots thereon. The first battery module housing has a first plurality of battery cells therein, the first battery module housing having: a first side plate including a first cross-member integrally formed and including a first interlocking member; and a second side plate including a second interlocking member. The second battery module housing a second plurality of battery cells therein, the second battery module having: a first side plate including a second cross-member integrally formed thereon and including a first interlocking member; and a second side plate including a second interlocking member; wherein the first interlocking member of the first battery module receives the second interlocking member of the second battery module.

### FIELD

The present application generally relates to electrified vehicles and, more particularly, to a battery module assembly having a battery module housing including a collection of interlocking battery modules received in a battery frame.

### BACKGROUND

An electrified vehicle (hybrid electric, plug-in hybrid electric, range-extended electric, battery electric, etc.) includes at least one battery system and at least one electronic drive module having an electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. The high voltage battery system generally includes a battery pack or module assembly that includes a housing that houses one or more battery modules. Conventional battery module assemblies often require multiple structural components to ensure the integrity and safety of the battery system, leading to increased weight, manufacturing complexity, and cost. Conventional battery module assemblies also require extensive fasteners or other methods of coupling the individual modules to cross members arranged within the main battery pack. Accordingly, while such battery module assemblies do work well for their intended purpose, there is a desire for improvement in the relevant art.

### SUMMARY

According to one example aspect of the invention, a battery module assembly includes a battery frame, a first and a second cross-member bracket; a first battery module and a second battery module. The first and second cross-member brackets are configured on the battery frame and define first opposing slots thereon. The first battery module housing has a first plurality of battery cells therein, the first battery module housing having: a first side plate including a first cross-member integrally formed thereon, the first cross-member including a first interlocking member; and a second side plate including a second interlocking member. The second battery module housing a second plurality of battery cells therein, the second battery module having: a first side plate including a second cross-member integrally formed thereon, the second cross-member including a first interlocking member; and a second side plate including a second interlocking member; wherein the first interlocking member of the first battery module receives the second interlocking member of the second battery module.

In some implementations, the first cross-member is received by the opposing slots of the first and second cross-member brackets.

In some implementations, the first cross-member bracket includes complementary fingers that define a first slot of the opposing slots.

In some implementations, the second cross-member bracket includes complementary fingers that define a second slot of the opposing slots.

In some implementations, the battery frame is formed of aluminum. In other examples, the battery frame can be formed of other materials such as, but not limited to, composite, plastic, steel, etc.

In additional aspects, the first battery module further includes third and fourth side plate that respectively connect between the first and second side plates.

In additional features, the first battery module further includes a top plate positioned at a top boundary of the first battery module and bottom plate positioned at a bottom boundary of the first battery module, wherein the first plurality of battery cells are received by the first battery module between the first, second, third, fourth, fifth and sixth plates.

In other features, the first side plate is formed of extruded aluminum.

In additional arrangements, the battery module assembly includes a third and a fourth cross member bracket configured on the battery frame and defining opposing second slots thereon.

In some examples, the first and second cross-members of the respective first and second battery modules are configured to be collectively and concurrently received by the opposing first and second slots.

In implementations, the first and second cross-members are slidably received at the first and second slots.

In examples, the frame is formed of extruded aluminum.

In other examples, an electrified vehicle includes an electrified powertrain and a battery module assembly. The battery module assembly includes a battery frame, a first and a second cross-member bracket; a first battery module and a second battery module. The first and second cross-member brackets are configured on the battery frame and define first opposing slots thereon. The first battery module housing has a first plurality of battery cells therein, the first battery module housing having: a first side plate including a first cross-member integrally formed thereon, the first cross-member including a first interlocking member; and a second side plate including a second interlocking member. The second battery module housing a second plurality of battery cells therein, the second battery module having: a first side plate including a second cross-member integrally formed thereon, the second cross-member including a first interlocking member; and a second side plate including a second interlocking member; wherein the first interlocking member of the first battery module receives the second interlocking member of the second battery module.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery pack assembly according to various principles of the present application;

FIG. 2 is a top perspective view of a battery module frame constructed in accordance to one Prior Art example;

FIG. 3 is a detail view of a portion of the Prior Art battery module assembly including the battery module frame of FIG. 2 showing an external extrusion frame, a cross member bracket, a main cross member, a battery module and a battery fastener;

FIG. 4 is a top perspective view of a battery module assembly including a battery frame that receives a plurality of battery modules according to various principles of the present application;

FIG. 5 is view of a battery module of the plurality of battery modules shown in FIG. 4, the battery module shown having a first side plate and an opposite second side plate, the first side plate having a cross-member integrated directly into the first side plate and including a first interlocking member, the second side plate including a second interlocking member according to various principles of the present application;

FIG. 6 is a partial exploded assembly view of two adjacent battery modules shown aligned for interlocking assembly where a first interlocking member of one battery module interlocks with a second interlocking member of an adjacent battery module according to various principles of the present application;

FIG. 7 is a partial sectional side view taken along line 7-7 of the battery module assembly showing three battery modules assembled in an interlocked position according to various principles of the present application;

FIG. 8 is a detail view of two cross-member brackets of the battery module assembly of FIG. 4 according to various principles of the present application; and

FIG. 9 is an exemplary assembly step illustrating a plurality of battery modules coupled to each other in an interlocking fashion and aligned for receipt into the battery frame wherein the respective cross-members are slidingly received by complementary cross-member brackets extending from the external extrusion of the battery frame according to various principles of the present application.

### DESCRIPTION

As discussed above, a high voltage battery system in an electrified vehicle generally includes a battery pack or module assembly that includes a housing that houses one or more battery modules. Conventional battery module assemblies often require multiple structural components to ensure the integrity and safety of the battery system, leading to increased weight, manufacturing complexity, and cost. Conventional battery module assemblies also require extensive fasteners or other methods of coupling the individual modules to cross members arranged within the main battery pack.

The instant disclosure provides a battery module assembly having a battery module housing including a collection of interlocking battery modules received in a battery frame. The battery module assembly of the present disclosure mitigates the drawbacks associated with conventional battery module assemblies including, but not limited to, complexity and weight associated with the structural design of electrified vehicle battery packs. In particular, each battery module has a first side plate and an opposite second side plate, the first side plate provides a cross-member integrated directly into the first side plate and having a first interlocking member. The second side plate includes a second interlocking member according to various principles of the present application.

Adjacent battery modules are aligned for interlocking assembly where a first interlocking member of one battery module interlocks with a second interlocking member of an adjacent battery module. The battery module assembly of the present disclosure reduces the number of components needed, thereby decreasing the overall weight and simplifying the manufacturing process. Additionally, it eliminates the operation of fastening individual modules to the main battery pack cross members. The battery module assembly is formed of aluminum reducing weight. Moreover, the streamlined design maximizes the available space for battery cells, improving the density and efficiency of the battery module and fill rate of the battery module assembly as a whole.

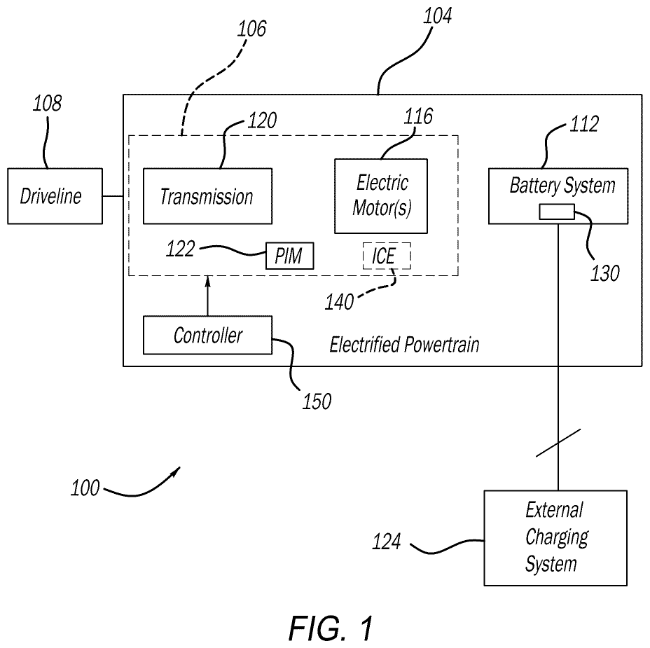

Referring now to FIG. 1, a functional block diagram of an example electrified vehicle 100 (also referred to herein as “vehicle 100”) according to the principles of the present application is illustrated. The vehicle 100 includes an electrified powertrain 104 having an electric drive module (EDM) 106 configured to generate and transfer drive torque to a driveline 108 for vehicle propulsion. The EDM 106 generally includes one or more electric drive units or motors 116 (e.g., electric traction motors), an electric drive gearbox assembly or transmission 120, and power electronics including a power inverter module (PIM) 122.

The electric motor 116 is selectively connectable via the PIM 124 to a high voltage battery system 112 for powering the electric motor 116. The battery system 112 is selectively connectable (e.g., by the driver) to an external charging system 124 (also referred to herein as “charger 124”) for charging of the battery system 112. The battery system 112 includes at least one battery module assembly 130. In some examples, the electrified powertrain 104 can be a hybrid powertrain that additionally includes an internal combustion engine 140. A heating cooling and air conditioning (HVAC) system 142 can provide communicate air to various systems of the electrified vehicle 100 such as to the EDM 106 and the battery system 112. A controller 150 can provide various inputs to the EDM 106 related to selectively switching power inputs between the electric motors 116 and the ICE 140.

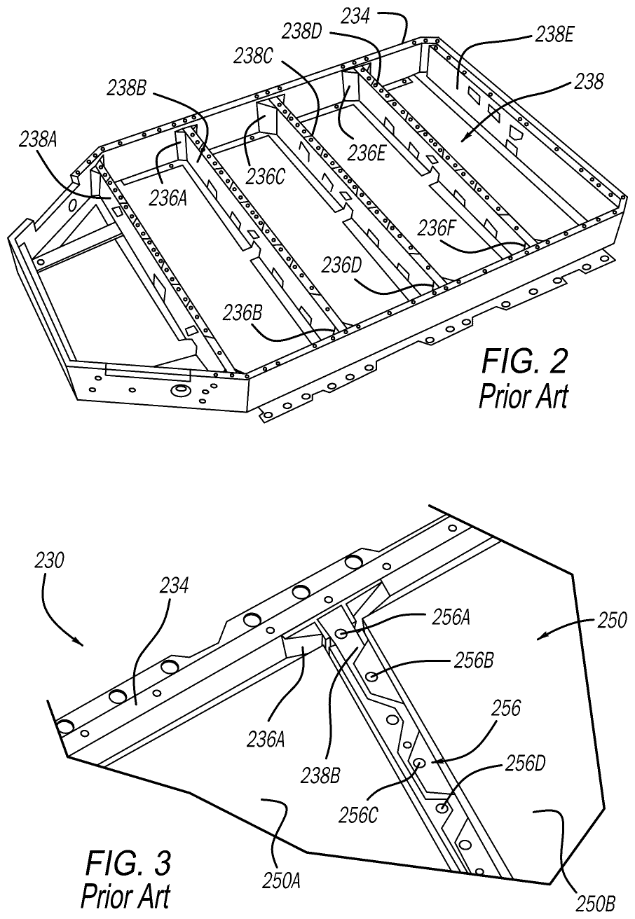

With additional reference now to FIGS. 2 and 3, a battery module assembly 230 constructed in accordance to one Prior Art example will be described. The battery module assembly 230 generally includes an external extrusion frame 234, cross member brackets collectively identified at reference numeral 236 and individually identified at reference numerals 236A-236F, main cross-members collectively identified at reference numeral 238 and individually identified at reference numerals 238A-238E, battery modules collectively identified at reference numeral 250 and individually identified at reference numerals 250A and 250B and a plurality of battery fasteners collectively identified at reference numeral 256 and individually identified at reference numerals 256A-256D.

The battery module assembly 230 presents various drawbacks and deficiencies. For example, multiple and heavier components provide undesirable weight and complexity for assembly that ultimately lead to elevated component and assembly costs. Further, the battery module assembly 230 has reduced space efficiency as these additional components take up valuable space within the battery pack. In addition, there is potential for decreased reliability due to the complexity of connections and joints between different structural elements and welds.

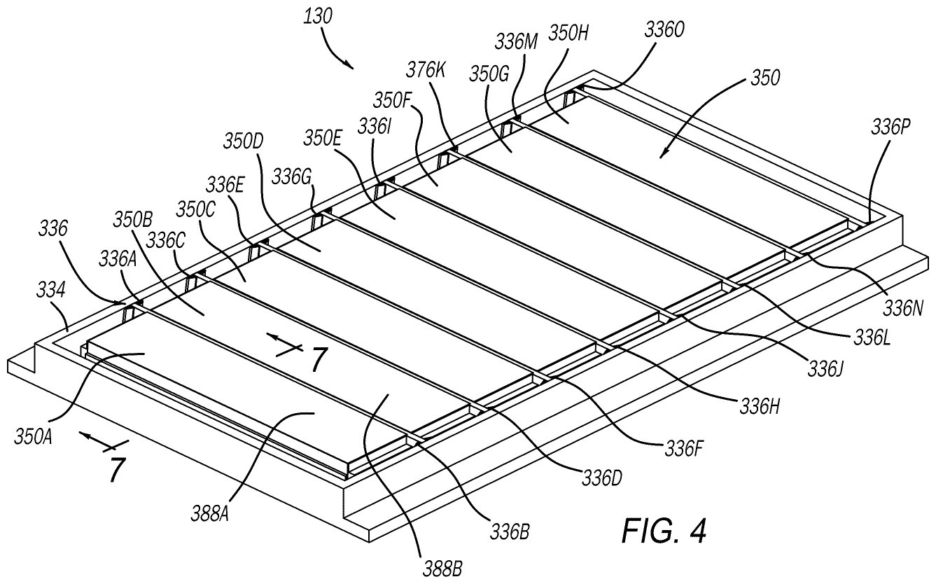

Turning now to FIGS. 4-9, the battery module assembly 130 constructed in accordance to various examples of the present disclosure will be described. The battery module assembly 130 includes a battery frame 334 that receives a plurality of battery modules, collectively identified at reference 350 and individually identified at reference numerals 350A-350H. The battery module assembly 330 generally includes cross member brackets collectively identified at reference numeral 336 and individually identified at reference numerals 336A-336P. The battery frame can be formed of aluminum. In other examples, the battery frame can be formed of other materials such as, but not limited to, composite, plastic, steel, etc. In examples where composite or plastic is used, it is contemplated that the brackets described herein can be included within a molding that forms the frame. This would allow the frame configuration to accept the battery modules without an added welding step (brackets to the frame). Other configurations are contemplated.

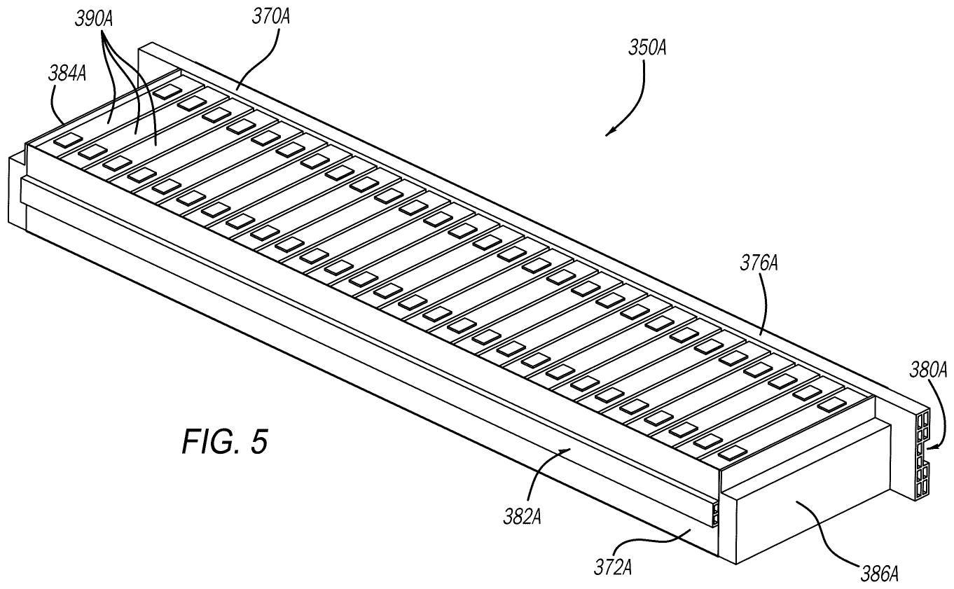

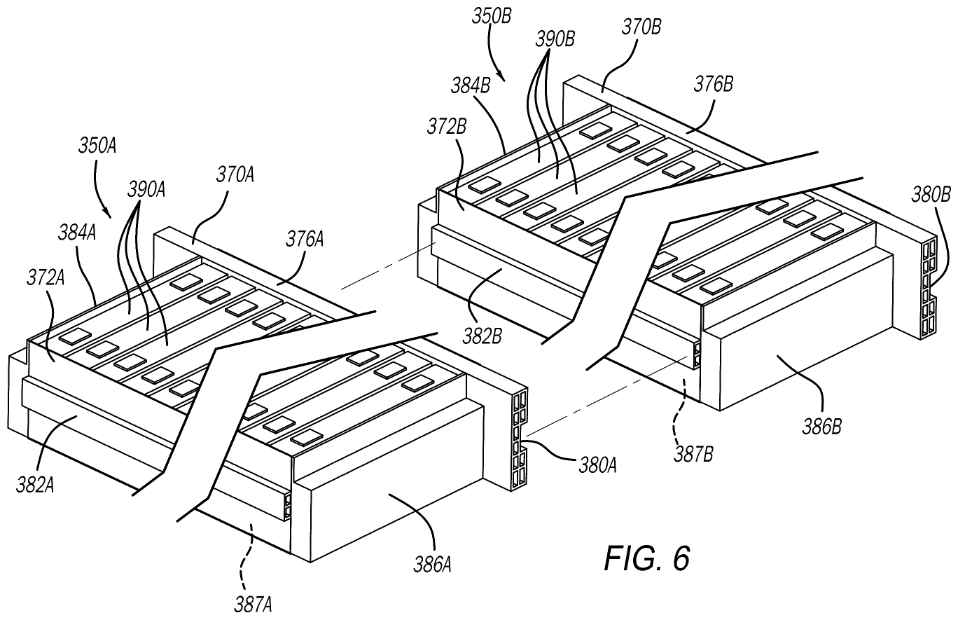

With particular reference now to FIGS. 5 and 6, additional description of the battery module assembly 130 will be described. The battery module 350A is shown having a first side plate 370A and an opposite second side plate 372A. The first side plate 370A has a first cross-member 376A integrated directly into the first side plate 370A. The first cross-member 376A further includes a first interlocking member 380A. The second side plate 372A includes a second interlocking member 382A according to various principles of the present application. A third and fourth side plate 384A and 386A, respectively connect between the first and second side plates 370A and 372A. A bottom plate 387A and a top plate 388A (FIG. 4) are positioned at bottom and top boundaries of the battery module 350A. A plurality of battery cells 390A are shown received by the battery module 350A generally between the first, second, third, fourth, fifth and sixth plates 370A, 372A, 384A, 386A, 387A and 388A. The side plates 370A, 372A, 384A, 386A, 387A and 388A can be formed of extruded aluminum.

The battery module 350B is shown having a first side plate 370B and an opposite second side plate 372B. The first side plate 370B has a first cross-member 376B integrated directly into the first side plate 370B. The first cross-member 376B further includes a first interlocking member 380B. The second side plate 372B includes a second interlocking member 382B according to various principles of the present application. A third and fourth side plate 384B and 386B, respectively connect between the first and second side plates 370B and 372B. A bottom plate 387B and a top plate 388B (FIG. 4) are positioned at bottom and top boundaries of the battery module 350B. A plurality of battery cells 390B are shown received by the battery module 350B generally between the first, second, third, fourth, fifth and sixth plates 370B, 372B, 384B, 386B, 387B and 388B. The first, second, third, fourth, fifth and sixth plates 370B, 372B, 384B, 386B, 387B and 388B can be formed of extruded aluminum.

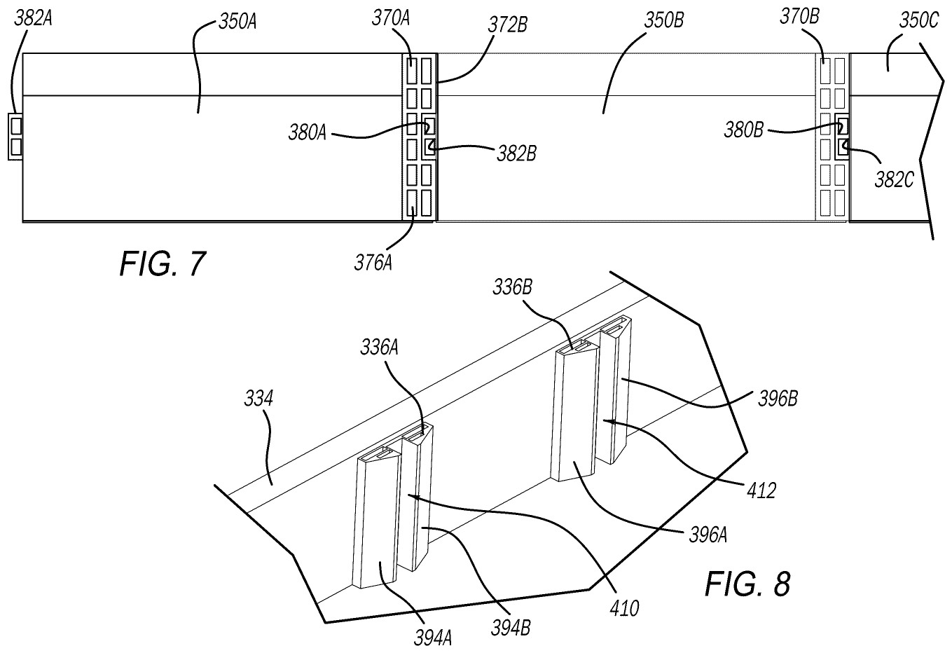

FIG. 7 is a partial sectional side view taken along line 7-7 of the battery module assembly 130 showing three battery modules 350A, 350B and 350C assembled in an interlocked position. Notably, the first interlocking member 380A of the first battery module 350A is shown receiving the second interlocking member 382B of the second battery module 350B. Similarly, the first interlocking member 380B of the second battery module 350B is shown receiving a second interlocking member 382C of the third battery module 350C.

FIG. 8 is a detail view of two cross-member brackets 336A and 336C of the battery module assembly 130. The cross-member bracket 336A provides complementary fingers 394A and 394B. The cross-member bracket 336B provides complementary fingers 396A and 396B. The complementary fingers 394A and 394B define a first slot 410 therebetween. The complementary fingers 396A and 396B define a first slot 412 therebetween. It is appreciated that all of the modules 350 incorporate similar features for interlocking with adjacent modules 350.

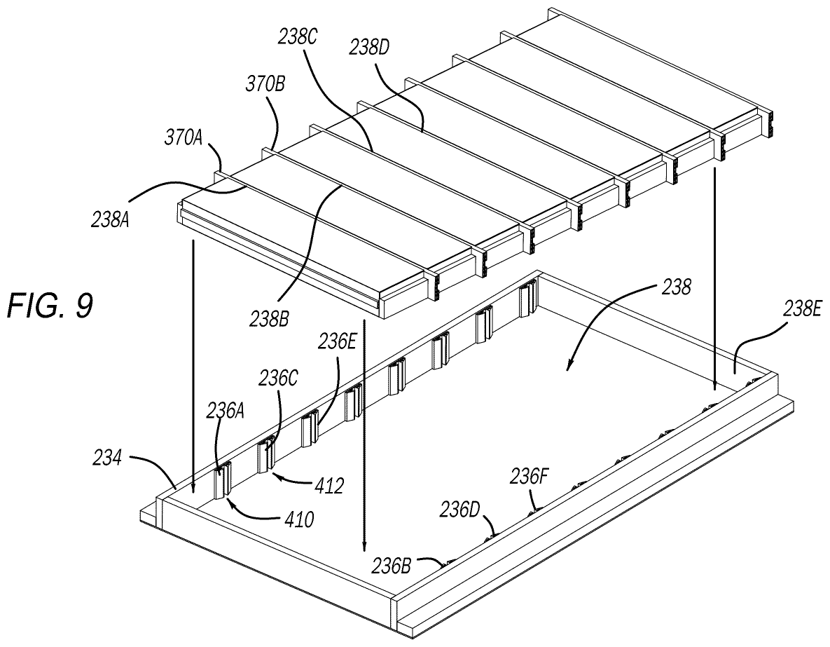

FIG. 9 is an exemplary assembly step illustrating a plurality of battery modules 350 coupled to each other in an interlocking fashion and aligned for receipt into the battery frame 334 wherein the respective cross-members 370 are slidingly received by the slots (e.g., 410, 410, etc.) of the complementary cross-member brackets 336 extending from the external extrusion of the battery frame 334.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A battery module assembly comprising:
a battery frame;
a first and a second cross-member bracket configured on the battery frame and defining first opposing slots thereon;
a first battery module that houses a first plurality of battery cells therein, the first battery module having:
a first side plate including a first cross-member integrally formed thereon, the first cross-member including a first interlocking member; and
a second side plate including a second interlocking member; and
a second battery module housing a second plurality of battery cells therein, the second battery module having:
a first side plate including a second cross-member integrally formed thereon, the second cross-member including a first interlocking member; and
a second side plate including a second interlocking member;
wherein the first interlocking member of the first battery module receives the second interlocking member of the second battery module.

2. The battery module assembly of claim 1, wherein the first cross-member is received by the opposing slots of the first and second cross-member brackets.

3. The battery module assembly of claim 1, wherein the first cross-member bracket includes complementary fingers that define a first slot of the opposing slots.

4. The battery module assembly of claim 3, wherein the second cross-member bracket includes complementary fingers that define a second slot of the opposing slots.

5. The battery module assembly of claim 1, wherein the battery frame is formed of aluminum.

6. The battery module assembly of claim 1, wherein the first battery module further includes third and fourth side plate that respectively connect between the first and second side plates.

7. The battery module assembly of claim 6, wherein the first battery module further includes a fifth top plate positioned at a top boundary of the first battery module and bottom sixth plate positioned at a bottom boundary of the first battery module, wherein the first plurality of battery cells are received by the first battery module between the first, second, third, fourth, fifth and sixth plates.

8. The battery module assembly of claim 1, wherein the first side plate is formed of extruded aluminum.

9. The battery module assembly of claim 1, further comprising:
a third and a fourth cross member bracket configured on the battery frame and defining opposing second slots thereon.

10. The battery module assembly of claim 1, wherein the first and second cross-members of the respective first and second battery modules are configured to be collectively and concurrently received by the opposing first and second slots.

11. The battery module assembly of claim 10, wherein the first and second cross-members are slidably received at the first and second slots.

12. The battery module assembly of claim 1, wherein the frame is formed of extruded aluminum.

13. An electrified vehicle comprising:
an electrified powertrain that generates and transfers drive torque to a driveline of the electrified vehicle;
a battery module assembly including:
a battery frame;
a first and a second cross-member bracket configured on the battery frame and defining first opposing slots thereon;
a first battery module housing a first plurality of battery cells therein, the first battery module having:
a first side plate including a first cross-member integrally formed thereon, the first cross-member including a first interlocking member; and
a second side plate including a second interlocking member; and
a second battery module housing a second plurality of battery cells therein, the second battery module having:
a first side plate including a second cross-member integrally formed thereon, the second cross-member including a first interlocking member; and
a second side plate including a second interlocking member;
wherein the first interlocking member of the first battery module receives the second interlocking member of the second battery module.

14. The electrified vehicle of claim 13, wherein the first cross-member is received by the opposing slots of the first and second cross-member brackets.

15. The electrified vehicle of claim 13, wherein the first cross-member bracket includes complementary fingers that define a first slot of the opposing slots.

16. The electrified vehicle of claim 15, wherein the second cross-member bracket includes complementary fingers that define a second slot of the opposing slots.

17. The electrified vehicle of claim 13, wherein the battery frame is formed of aluminum.

18. The electrified vehicle of claim 13, wherein the first battery module further includes third and fourth side plate that respectively connect between the first and second side plates.

19. The electrified vehicle of claim 18, wherein the first battery module further includes a top plate positioned at a top boundary of the first battery module and bottom plate positioned at a bottom boundary of the first battery module, wherein the first plurality of battery cells are received by the first battery module between the first, second, third, fourth, fifth and sixth plates.

20. The electrified vehicle of claim 13, wherein the first side plate is formed of extruded aluminum.
